(19) United States
(12) Patent Application Publication
(10) Pub. No.: US 2008/0101710 A1
(43) Pub. Date: May 1, 2008

(54) Image processing device and imaging device

(76) Inventor: Toshinobu Hatano, Kyoto (JP)

Correspondence Address: MCDERMOTT WILL & EMERY LLP, 600 13TH STREET, NW, WASHINGTON, DC, 20005-3096, US

(21) Appl. No.: 11/976,493

(22) Filed: Oct. 25, 2007

(30) Foreign Application Priority Data
Oct. 25, 2006 (JP) 2006-289501

(51) Int. Cl. H04N 7/26

(52) U.S. Cl. 382/238; 375/E07.123; 375/240.16

(57) ABSTRACT

An image processing device according to the present invention comprises a motion detection processor for detecting a motion vector of image data, a particular region detection processor for detecting a particular region in the image data based on an imaging cycle of the image data and generating particular region position information, and a particular region corrector for calculating a predicted motion amount of the image data between frames based on the motion vector and calculating predicted particular region position information by adding the predicted motion amount to the particular region position information.

### BACKGROUND OF THE INVENTION

1. Field of the Invention

The present invention relates to an image processing device installed in a digital camera, a mobile telephone, a personal computer and the like, more particularly to a technology for improving an accuracy in detecting a particular region when an image of a moving person is obtained.

2. Description of the Related Art

In recent years, a digital still camera in which a film and its development can be dispensed with has been booming, and many of mobile telephones available now are provided with a built-in camera. Under the circumstances, remarkable improvements have been continuously achieved in a processing speed and an image quality in a digital still camera. When a person is photographed, it is important not only to immediately respond to a motion of the photographic subject and camera shake but also to make it unnecessary to recompose the picture between when the focus is automatically obtained and when the shutter is pressed. So far was proposed such an imaging device as shown in FIG. 6 in which a particular region of the subject in a screen such as a face region is detected in order to obtain the focus so that the person is imaged with an exposure optimal to the particular region. An example of the technology is recited in Japanese Paten Laid-Open no. 2005-318554 of the Japanese Patent Documents, which is hereinafter referred to as a first conventional technology.

In the first conventional technology, while an A/D-converted image data is memorized as a first image data, the first image data is further subjected to predetermined processing and memorized as a second image data. Then, a particular region is detected from the second image data. While the particular region is being detected, the image is displayed based on the A/D-converted first image data. When the detection of the particular region is completed, necessary information is extracted from a part of the first image data corresponding to the particular region and subjected to processing such as autofocus, automatic exposure and white balance. In this case, the processing, such as the autofocus, automatic exposure and white balance, can immediately follow the person's motion because the particular region is detected from the image data used exclusively for the detection of the particular region in a photographing sequence.

There was proposed another technology in which the previous data is utilized in such a manner that the movement of the particular region between I frames is predicted from a motion vector in order to alleviate the detection processing of the particular region in a given I frame in compressed data. An example of the technology is recited in U.S. Pat. No. 6,298,145, which is hereinafter referred to as a second conventional technology.

However, the first conventional technology is disadvantageous in that it takes time to detect the particular region of the person when a continuous frame processing, which corresponds to a moving image reading operation by a sensor, is realized. Therefore, it is necessary to constantly store a plurality of image data comparable to delay time per frame in a memory, which results in more frequent accesses to the memory when evaluation values of the autofocus, automatic exposure and white balance are detected from the image data used exclusively for the detection of the particular region.

The second conventional technology is simply capable of predicting the movement of the face position between the I frames from the motion vector. In this case, a correction accuracy cannot be really high because a prediction cycle in a time-base direction is extended. Therefore, in the case of a photographic subject which is moving relatively fast, it is not possible to accurately correct the change of the position of the particular region in accordance with the movement.

### SUMMARY OF THE INVENTION

Therefore, a main object of the present invention is to provide an image processing device capable of accurately detecting a particular region without increasing a memory load and increasing accesses with respect to a memory.

In order to achieve the foregoing object, an image processing device according to the present invention comprises:

a motion detection processor for detecting a motion vector of image data;

a particular region detection processor for detecting a particular region in the image data based on an imaging cycle of the image data and generating a particular region position information; and

a particular region corrector for calculating a predicted motion amount between imaging periodical points of the image data based on the motion vector and calculating a predicted particular region position information by adding the predicted motion amount to the particular region position information.

In the foregoing constitution, the motion detection processor detects the motion vector in the image data. The particular region detection processor detects the particular region in the image data and generates the particular region position information. Further, the particular region corrector calculates the predicted motion amount between the imaging periodic points of the image data based on the motion vector, and adds the predicted motion amount to the particular region position information to thereby calculate the predicted particular region position information. Thus, the predicted particular region position information which is corrected in such a manner that the predicted motion amount is added to the particular region position information can be obtained. Therefore, though it takes time to detect the particular position based on the imaging cycle of the image data, the position information of the particular region can be accurately corrected and outputted. The processing required by the foregoing operation is the calculation of the predicted motion amount from the motion vector and the addition of the predicted motion amount to the particular region position information. Therefore, the detection (correction) of the particular region can be realized with a higher accuracy without increasing the load and accesses with respect to the memory.

An optimum example of the particular region is a face region of a person as a photographic subject.

The particular region corrector may preferably calculate the predicted particular region position information by adding the predicted motion amount corresponding to a time difference (positional difference) from the imaging periodic point at which the detection of the particular region by the particular region detection processor starts to the imaging periodic point at which a particular region detection frame is displayed to the particular region position information when the predicted motion amount is calculated. The particular region corrector thus constituted is effective in a constitution where on-screen data for displaying the particular region detection frame at a coordinate position on a screen shown by the predicted particular region position information is generated, in other words, in a constitution where the particular region detection frame showing a position and dimensions of the particular region is displayed in such a manner that the particular region detection frame is superimposed on a position of a person or the like in a moving image of a corresponding display frame.

In the foregoing constitution, the predicted motion amount corresponding to the time difference from the imaging periodic point at which the detection of the particular region starts to the imaging periodic point at which the particular region detection frame is displayed is calculated, and the calculated predicted motion amount is added to the particular region position information so that the predicted particular region position information is determined. As a result, the particular region detection frame can be displayed in a superimposing manner in a state where timing of the detection of the particular region and timing of the display match.

The particular region corrector may preferably calculate the predicted particular region position information by adding the predicted motion amount corresponding to a time difference (positional difference) from the imaging periodic point at which the detection of the particular region by the particular region detection processor starts to the imaging periodic point at which the image data is fetched to the particular region position information when the predicted motion amount is calculated at the imaging periodic point at which a next sensor signal (image data) is fetched. The particular region corrector thus constituted is effective in a constitution where a coordinate position on the screen shown by the predicted particular region position information is indicated as a coordinate position on the screen where an evaluation value used for at least one of the autofocus, automatic exposure and white balance is obtained.

Accordingly, the particular region position information at the time when the evaluation value for the autofocus, automatic exposure or white balance is calculated is predicted and fed back at the imaging periodic point at which the next image data is fetched. In this manner, the predicted motion amount corresponding to the time difference from the imaging periodic point at which the detection of the particular region starts to the imaging periodic point at which the image data is fetched is calculated, and the calculated predicted motion amount is added to the particular region position information so that the predicted particular region position information is determined. As a result, the evaluation value for the autofocus, automatic exposure or white balance can be obtained in a state where the timing of obtaining the evaluation value and the display timing match.

The image processing device according to the present invention may preferably further comprise a resizing processor for size-reducing the image data to be displayed and gain-adjusting the size-reduced image data and also size-reducing the image data for the detection of the particular region and gain-adjusting the size-reduced image data, wherein

the particular region detection processor detects the particular region based on the image data size-reduced by the resizing processor. Accordingly, the particular region and the motion vector can be both detected while an arbitrary image is being displayed.

The image processing device according to the present invention may preferably further comprise:

a first resizing processor for size-reducing the image data to be displayed and gain-adjusting the size-reduced image data;

a second resizing processor for size-reducing the image data size-reduced for display so that the image data is used for the detection of the particular region and gain-adjusting the size-reduced image data; and

a particular region detection memory in which the image data size-reduced for the detection of the particular region is stored, wherein

the particular region detection processor detects the particular region based on the image data size-reduced for the detection of the particular region which is read from the particular region detection memory. As a result, the particular region and the motion vector can be both detected without the display of any arbitrary image.

According to the present invention, the predicted particular region position information corrected in such a manner that the predicted motion amount is added to the particular region position information can be obtained. Therefore, though it may take time to detect the particular region based on the imaging cycle of the image data in order to obtain an accurate result in the detection of the position of the particular region, the accurate detection result can be obtained and post-processing such as the display can be performed based on such accurate detection result. Further, the necessary operations are the calculation of the predicted motion amount from the motion vector and the addition of the predicted motion amount to the particular region position information. Therefore, the particular region can be detected with an improved accuracy without increasing the load and accesses with respect to the memory. As a result, the autofocus, automatic exposure and white balance can be performed in a stable manner when a person is photographed.

The image processing device according to the present invention is superior in accuracy in detecting a particular region when a photographic subject is moving at a high speed. Therefore, an image with a high quality can be obtained through the stable operations of the autofocus, automatic exposure and white balance in a digital camera or a mobile telephone.

### BRIEF DESCRIPTION OF THE DRAWINGS

These and other objects as well as advantages of the invention will become clear by the following description of preferred embodiments of the invention, and they will be specified in the claims attached hereto. A number of benefits not recited in this specification will come to the attention of the skilled in the art upon the implementation of the present invention.

FIG. 1 is a block diagram illustrating a constitution of an imaging device in which an image processing device according to preferred embodiments of the present invention is incorporated.

FIG. 2 is a block diagram illustrating a constitution of an image processing device according to a preferred embodiment 1 of the present invention.

FIG. 3 is an illustration of frame time transition in each type of processing in an image processing sequence according to the preferred embodiments of the present invention.

FIG. 4 is an illustration of a specific example of image processing with respect to an image of a moving person.

FIG. 5 is a block diagram illustrating a constitution of an image processing device according to a preferred embodiment 2 of the present invention.

FIG. 6 is a block diagram illustrating a constitution of an imaging device according to a conventional technology.

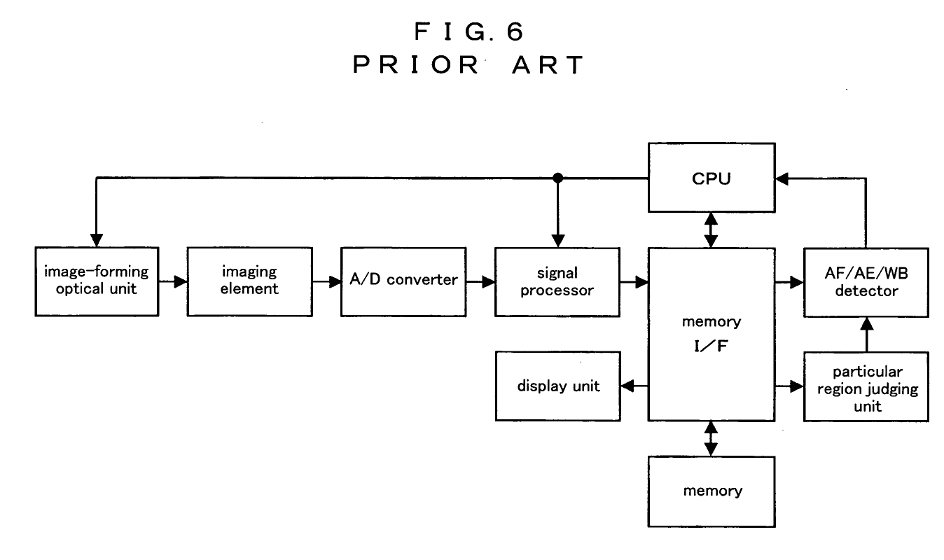

### DETAILED DESCRIPTION OF THE INVENTION

Hereinafter, preferred embodiments of an image processing device according to the present invention are described in detail referring to the drawings.

### Preferred Embodiment 1

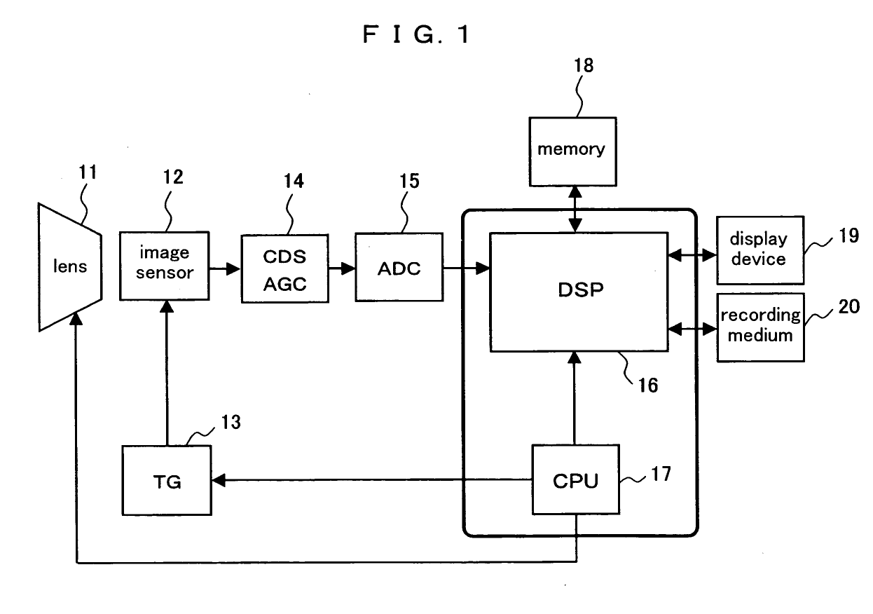

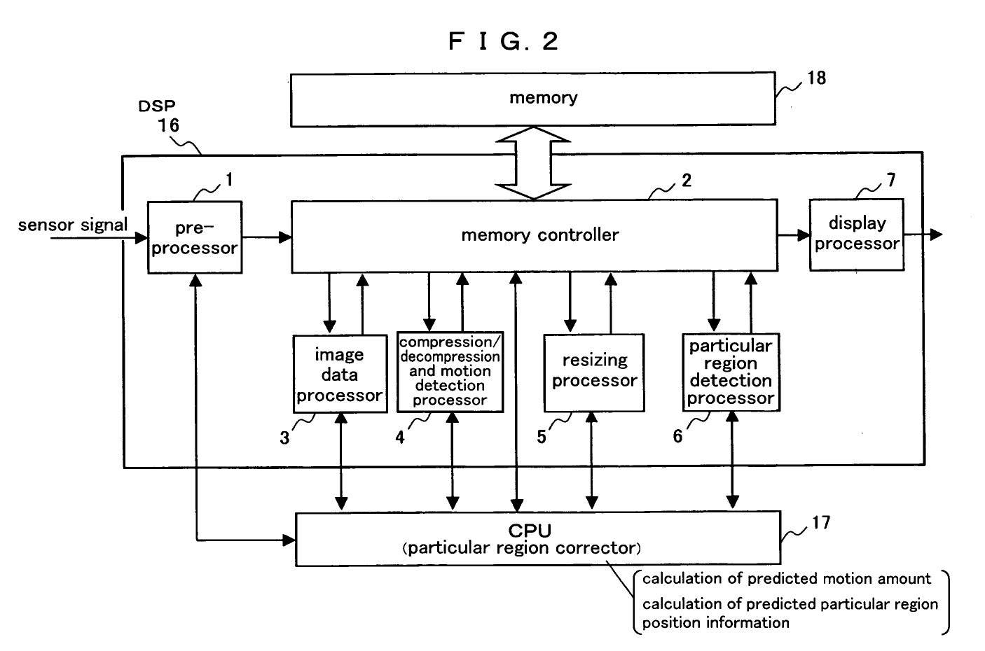

FIG. 1 is a block diagram illustrating a constitution of an imaging device in which an image processing device according to a preferred embodiment 1 of the present invention is incorporated. FIG. 2 is a block diagram illustrating a constitution of an image processing device according to the preferred embodiment 1 of the present invention. Referring to FIG. 1, the imaging device is described. Referring to reference numerals shown in FIG. 1, 11 denotes a lens unit including a photographic lens. 12 denotes a two-dimensional image sensor, 13 denotes a timing generator (TG) for generating a drive pulse of the image sensor 12, 14 denotes a CDS/AGC circuit for removing noise of an imaging video signal outputted from the image sensor 12 and controlling a gain thereof, 15 denotes an A/D converter (ADC) for converting an analog video signal into digital image data, 16 denotes a DSP (digital signal processing circuit) for executing various types of processing (including detection of a particular region and detection of a motion) by executing a predetermined program, 17 denotes a CPU (microcomputer) for controlling a general system operation of the imaging device using a control program, 18 denotes a memory in which image data and various types of data are stored, 19 denotes a display device, and 20 denotes a recording medium. The image processing device according to the present preferred embodiment comprises the DSP 16 and the CPU 17, and an imaging unit comprises the lens 11, image sensor 12, timing generator (TG) 13, CDS/AGC circuit 14 and A/D converter (ADC) 15.

Next, the operation of the imaging device according to the present preferred embodiment is described. First, a typical imaging and recording operation is described. When an imaging light enters the image sensor 12 via the lens of the lens unit 11, an image of a photographic subject is converted into an electrical signal by a photodiode constituting the image sensor 12 or the like, and the electrical signal is outputted from the image sensor 12 based on vertical and horizontal drives synchronizing with the drive pulse from the timing generator 13. The electrical signal thus outputted from the image sensor 12 is an imaging video signal which is an analog continuous signal. The imaging video signal, after 1/f noise thereof is appropriately reduced by the sample hold circuit (CDS) of the CDS/AGC circuit 14, is automatically gain-controlled by the CDS/AGC circuit 14. The imaging video signal outputted from the CDS/AGC circuit 14 is converted into digital image data by the A/D converter 15. The obtained digital image data undergoes data-compressing processing including luminance signal processing, color-separation processing, color-matrix processing, resizing processing and motion vector detecting processing, and particular region detecting processing by the DSP 16. These types of processing is executed via the memory 18.

The processing mentioned above is regarded as processing of one sequence. The processing of one sequence is executed in parallel to frame data continuously outputted as outputs of moving images. The generated digital image data is displayed on the display device 19, and then, recorded in the recording medium 20 by the recording operation.

When the recorded data is reproduced, the digital image data is read from the recording medium 20. The read digital image data is resized to have a display size, and then, outputted to the display device 19. In the case where the read digital image data is compressed data, it is decompressed.

Referring to reference numerals shown in FIG. 2 which illustrates details of the DSP 16, 1 denotes a pre-processor for executing pre-processing, such as black-level adjustment and gain adjustment, to the image data fetched into the DSP 16, 2 denotes a memory controller for controlling write/read of the image data between respective processors and the memory 18, 3 denotes an image data processor for executing luminance-signal processing and color-signal processing to the image data read from the memory 18 via the memory controller 2 and writing the processed image data back into the memory 18 as luminance data and color-difference data (or RGB data), 4 denotes a compression/decompression and motion detection processor for compressing and decompressing the luminance data and the color-difference data and outputting motion vector information for each unit pixel block. The detection of the motion vector is executed as an internal function of the compression of the moving image. 5 denotes a resizing processor for resizing in horizontal and vertical directions and gain-adjusting the original image data read from the memory 18 via the memory controller 2 (luminance data and color-difference data (or RGB data)) and writing the processed image data back into the memory 18. A reference numeral 6 denotes a particular region detection processor for detecting a particular region in the image data read from the memory 18. A reference numeral 7 denotes a display processor for transferring the image data to be displayed received from the memory controller 2 to the display device 19. The CPU 17 constitutes a particular region corrector. The particular region corrector exerts a function of calculating a predicted motion amount between frames based on the motion vector by the compression/decompression and motion detection processor 4 and a function of calculating predicted particular region position information by adding the predicted motion amount to particular region position information by the particular region detection processor 6.

Next, the operation of the image processing device according to the present preferred embodiment is described. The digital image data fetched into the DSP 16 is subjected to the pre-processing such as the black level adjustment and gain adjustment by the pre-processor 1. The pre-processed digital image data is written in the memory 18 via the memory controller 2. The image data processor 3 reads the digital image data written in the memory 18 via the memory controller 2 and executes the luminance signal processing and color-signal processing to the read digital image data to thereby generate the luminance data and color-difference data (or RGB data). Then, the image data processor 3 writes the generated luminance data and color-difference data (or RGB data) back into the memory 18 via the memory controller 2.

The resizing processor 5 reads the original image data from the memory 18 via the memory controller 2, resizes the read original image data in the horizontal and vertical directions, and writes the resized image data thus obtained back into the memory 18.

The particular region detection processor 6 reads the resized image data from the memory 18 via the memory controller 2 as the image data for the detection of a particular region, and detects a position, a dimension, a tilt and the like of the particular region (hereinafter, referred to as particular region position information) from the read resized image data based on an imaging cycle of the image data (frame unit). An optimum example of the particular region recited in this specification is a face region of a person as a photographic subject moving in a screen image; however, the particular region is not particularly limited to the face region as far as it is a given region of a main imaging object (photographic subject).

The compression/decompression and motion detection processor 4 periodically reads the resized image data from the memory 18 via the memory controller 2 in parallel with the detection of the particular region and compresses the read resized image data (moving image frame data), and then, writes the compressed image data back into the memory 18. The compressed image data is thereby stored in a space of the memory. At the time, the compression/decompression and motion detection processor 4 outputs the motion vector of basic block unit obtained as a result of the detection of the motion vector, which is intermediate processing of the compression, in accordance with the compressed image data. The motion vector outputted from the compression/decompression and motion detection processor 4 is stored in the memory 18 via the memory controller 2 or stored in an internal register of the compression/decompression and motion detection processor 4.

When the image data to be displayed is generated, the resizing processor 5 vertically and horizontally resizes the image data in its entire region. In the resizing processing, a size is set so that an optimum size for the display can be obtained. The resizing processor 5 outputs the obtained image data to be displayed to the display processor 7.

The CPU 17 functioning as the particular region corrector fetches the particular region position information obtained by the particular region detection processor 6, and fetches the motion vector in the vicinity of a relevant area obtained by the compression/decompression and motion detection processor 4. Then, the CPU 17 calculates a predicted motion amount in which a delay time up to the frame of the display of the particular region detection frame is reflected, based on the motion vector. Then, the CPU 17 further calculates the predicted particular region position information by adding the predicted motion amount to the particular region position information. The predicted motion amount corresponds to a time difference (positional difference) from a frame (imaging periodic point) at which the detection of the particular region starts to a frame (imaging periodic point) at which a particular region detection frame is displayed. The particular region detection processor 6 generates on-screen data for having the particular region detection frame displayed, based on the obtained predicted particular region position information. Then, the display processor 7 uses its on-screen display function to have the on-screen data of the particular region detection frame displayed in such a manner that it is superimposed on the resized image data. The series of processing described above is sequentially executed for each frame. Thus, the image data which is constantly changing is processed in real time and in parallel. In the display device 19, the particular region detection frame is displayed together with scenes of the moving image in such a manner that position-alignment and timing-adjustment are provided with respect to the particular region of the person in the moving image.

A cycle (processing unit time) necessary for the particular region to be sequentially detected by the particular region detection processor 6 is relatively longer than a cycle necessary for the image data to be sequentially fetched (that is, a cycle for fetching the image data, and frame cycle in the present preferred embodiment). Accordingly, when the detection of the particular region and fetching the image data are simultaneously started, the detection of the particular region cannot be completed before fetching the image data of a frame is completed. As a result, a difference in terms of time; that is, a relative delay, is generated between these two types of processing. Considering the current operation performance of the CPU 17, the relative delay is forced to be comparatively large. Due to such a reason, there are generated differences in terms of time and space between the frame of the image data (imaging periodic point) which serves as the basis of the detection of the particular region and the frame of the image data (imaging periodic point) in the scene of the moving image displayed when the on-screen data of the particular region detection frame is obtained. The CPU 17 executes the foregoing series of processing, calculates a predicted motion amount based on the motion vector, and corrects the difference based on the calculated predicted motion amount. More specifically, the CPU 17 calculates a predicted motion amount corresponding to the delay (more specifically, delay time) generated between the frame of the detection of the particular region (imaging periodic point) and the frame of the display of the particular region detection frame (imaging periodic point) based on the motion vector obtained by the compression/decompression and motion detection processor 4, and adds the calculated predicted motion amount to the particular region position information to thereby calculate the predicted particular region position information.

Thus, the CPU 17 can obtain the predicted particular region position information corrected in such a manner that the predicted motion amount is added to the particular region position information. Accordingly, the difference in terms of time generated between the display frame timing (imaging periodic point) by which the detection of the particular region, such as the face of the photographic subject, is completed and the display frame timing (imaging periodic point) by which the display frame for which the particular region is to be detected is present can be accurately corrected (this difference in terms of time appears as a spacial difference of the moving particular region on the image). Therefore, when the cycle at which the particular region is detected is reduced to the imaging cycle (frame cycle) of the image data in order to more accurately detect the particular region, the difference in terms of time and space generated in the detection result can be accurately corrected, and the detection result which was accurately corrected can be retrieved.

Further, a relatively small number of additional processes are necessary for the operation, that is, a process of calculating the predicted motion amount from the motion vector and a process of adding the predicted motion amount to the particular region position information. Therefore, the particular region can be more accurately detected without any increase of the load and accesses with respect to the memory. Accordingly, the autofocus, automatic exposure and white balance when a person is photographed can be operated in a stable manner.

After executing the foregoing processing, the CPU 17 feedbacks the calculated predicted particular region position information (calculated by adding the predicted motion amount to the particular region position information) to the pre-processor 1. The predicted motion amount corresponds to a time difference (positional difference) between the frame where the detection of the particular region starts and the frame where the sensor signal is fetched. After the execution of the feedback control, the CPU 17 indicates a coordinate position on the screen shown by the predicted particular region position information to the imaging unit as a coordinate position on the screen where the evaluation value used for at least one of the autofocus, automatic exposure and white balance is obtained in the frame where the next image data is fetched. Accordingly, the evaluation value necessary for the autofocus, automatic exposure or white balance can be accurately obtained in a state where the timing of obtaining the particular region and the display timing are consistent with each other. As a result, the autofocus, automatic exposure and white balance can be realized with a high accuracy.

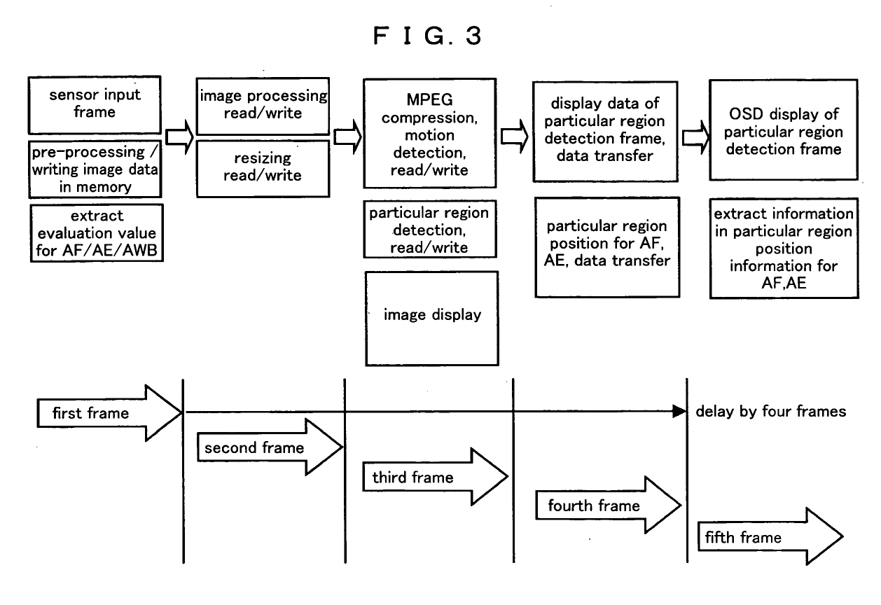

Referring to FIG. 3, a specific example of sequential image processing is described.

In a first frame,
the DSP 16 receives the image data (sensor signal) obtained in the imaging processing by the image sensor 12;
the DSP 16 writes the inputted image data in the memory 18 via the pre-processor 1 and the memory controller 2; and
the CPU 17 extracts the evaluation value for the autofocus, automatic exposure or white balance based on the inputted image data.

In a second frame,
the image data processor 3 executes the luminance signal processing and the color-signal processing to the image data read from the memory 18; and
the resizing processor 5 resizes the image data.

In a third frame,
the compression/decompression and motion detection processor 4 compresses the image data into the resized image data;
the compression/decompression and motion detection processor 4 detects the motion vector of basic block unit,
in parallel with the foregoing operation, the particular region detection processor 6 obtains the particular region position information from the resized image data;
the CPU 17 calculates the predicted motion amount in which the delay time up to the frame of the display of the particular region detection frame is reflected from the motion vector;
the CPU 17 adds the predicted motion amount to the particular region position information to thereby calculate the predicted particular region position information;
the CPU 17 generates the on-screen data for displaying the particular region detection frame based on the predicted particular region position information; and
the CPU 17 generates the image data to be displayed.

In a fourth frame,
the display processor 7 transfers the on-screen data of the particular region detection frame to the display device 19; and
the CPU 17 transfers the predicted particular region position information for the autofocus and automatic exposure to the pre-processor 1.

In a fifth frame,
the display device 19 displays the particular region detection frame in such a manner that it is superimposed on the obtained image using the on-screen display, and the particular region detection processor 6 extracts the information necessary in the autofocus and automatic exposure from the particular region.

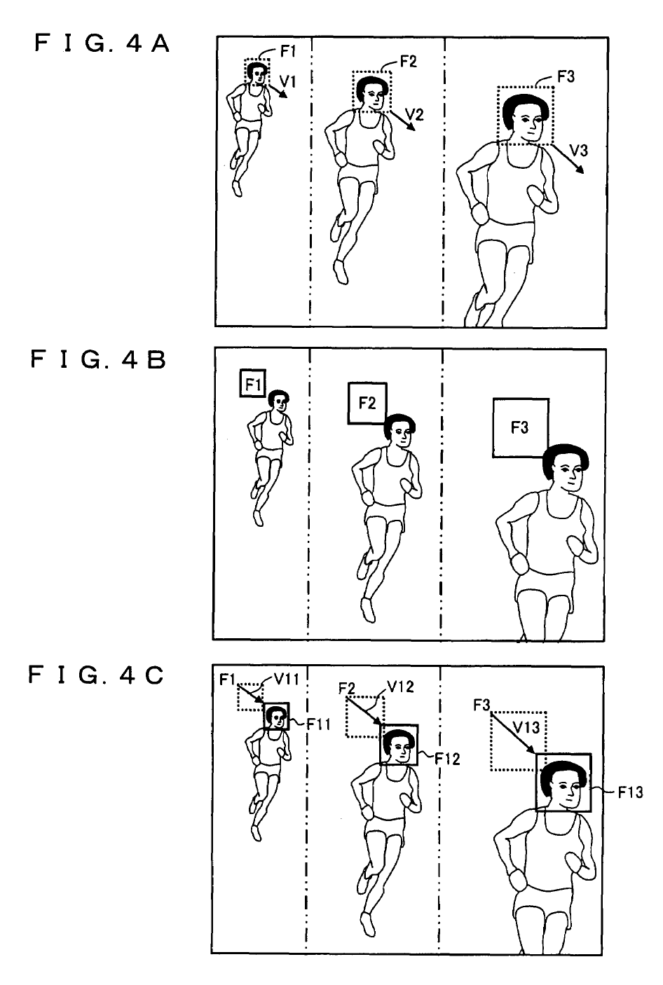

Next, a specific example of image processing with respect to a person's image is described referring to FIGS. 4A-4C. In FIGS. 4A-4C, a screen is divided into three areas to represent three independent scenes. In this example, the person is moving in the frames of the moving image.

In FIG. 4A, what is shown in dotted line is the information of the particular region detection frame obtained from the information on a specific central position and the dimensions of a particular region when the particular region is detected in an arbitrary image in the frames of the moving image. The particular region is detected per frame. In this example, particular region position information F1, F2 and F3 are obtained.

FIG. 4B shows moving images at timings by which the particular region position information F1, F2 and F3 are actually obtained after a certain amount of time (time necessary for the calculation) has passed since the calculation in FIG. 4A started. At the time, there is generated a difference between the position of the particular region which is displayed and the positions of the particular region shown by the particular region position information F1, F2 and F3 as the time passes. The positions shown by the particular region position information F1, F2 and F3 correspond to the position of the particular region in the frame which is earlier than the current frame by a few frames. Therefore, there is generated a positional difference between the actual position of the particular region and the position of the particular region in the displayed moving image when the particular region detection frame is directly displayed in a superimposing manner.

In order to correct the difference, motion vectors V1, V2 and V3 in the vicinity of a relevant area are obtained in advance in the frames of FIG. 4A. As shown in FIG. 4C, predicted motion amounts V11, V12 and V13 of the person between the frames of FIG. 4A and the frames of FIG. 4B are calculated based on the motion vectors V1, V2 and V3. In the case where there is a distance equivalent to two frames between the two frames, the predicted motion amounts V11, V12 and V13 are twice as large as the motion vectors V1, V2 and V3. In the case where there is a distance equivalent to three frames between the two frames, the predicted motion amounts V11, V12 and V13 are three times as large as the motion vectors V1, V2 and V3. When the predicted motion amounts V11, V12 and V13 are added to the particular region position information F1, F2 and F3 shown in FIG. 4B serving as the reference, predicted particular region position information F11, F12 and F13 are obtained.

Assuming that the number of the frames corresponding to the time delay required for the detection of the particular region between FIGS. 4A and 4B is n, the predicted motion amounts V11, V12 and V13 and the predicted particular region position information F11, F12 and F13 are calculated in the following formulas (1) and (2).

V11=n×V1, V12=n×V2, V13=n×V3 (1)

F11=F1+V11 F12=F2+V12 F13=F3+V13 (2)

When the time delay required for the detection of the particular region is corrected, the predicted particular region position information F11, F12 and F13 can be accurately displayed in an on-screen display manner at the position of the particular region of the person with matched timing as shown in FIG. 4C.

Then, by the display processor 7 the on-screen data of the particular region detection frame is displayed in such a manner that it is superimposed on the resized image data by the on-screen display function. This sequential processing is executed in parallel and in real time with respect to the image data which is constantly changing. Accordingly, in the display device 19, the scene of the moving image and the particular region detection frame are displayed in such a manner that the particular region detection frame is superimposed on the particular region in the moving image with matched timing and in a position-aligned manner.

In the case where the evaluation value which is necessary in the actual autofocus, automatic exposure or white balance is extracted in the pre-processing, the predicted motion amount of the particular region is added to the particular region position information in the image data inputted with such timing as the time advances, so that the particular region detection frame can be set as the area information where the position of the particular region is assumed.

### Preferred Embodiment 2

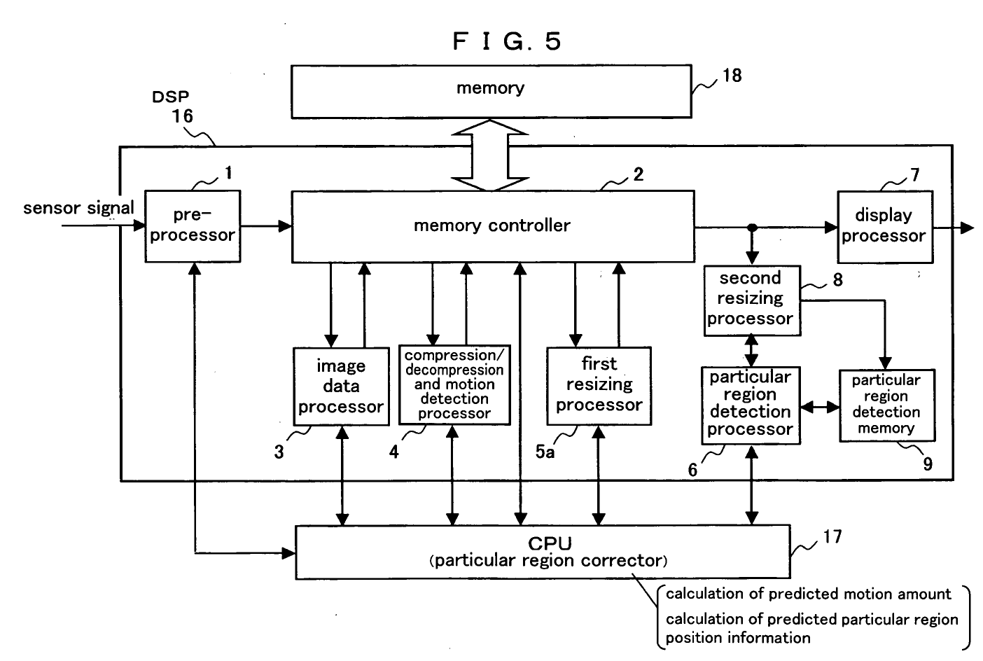

FIG. 5 is a block diagram illustrating a constitution of an image processing device according to a preferred embodiment 2 of the present invention. The same reference symbols as those shown in FIG. 1 according to the preferred embodiment 1 denote the same components. The present preferred embodiment is characterized in that data resized for display is as input image data for the detection of the particular region. In FIG. 5, 5a denotes a first resizing processor for reducing the size of the image data read from the memory 18 via the memory controller 2 and gain-adjusting the size-reduced image data. A reference numeral 8 denotes a second resizing processor for inputting image data for display transmitted from the memory controller 2 to the display processor 7, reducing the size of the inputted image data for the detection of a particular region and gain-adjusting the size-reduced image data. A reference numeral 9 denotes a particular region detection memory in which the image data size-reduced for the detection of the particular region by the second resizing processor 8 is stored. In the present preferred embodiment, the particular region detection processor 6 detects the particular region based on the image data size-reduced for the detection of the particular region which is read from the particular region detection memory 9. In the present preferred embodiment, an effect similar to that of the preferred embodiment is exerted.

In the preferred embodiments described so far, the internal intermediate processing function in the compression of the moving image is used to detect the motion vector. Alternatively, a single processing unit which independently detects the motion vector may be used.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. an image processing device comprising:
a motion detection processor for detecting a motion vector of image data;
a particular region detection processor for detecting a particular region in the image data based on an imaging cycle of the image data and generating a particular region position information; and
a particular region corrector for calculating a predicted motion amount between imaging periodical points of the image data based on the motion vector and calculating a predicted particular region position information by adding the predicted motion amount to the particular region position information.

2. The image processing device as claimed in claim 1, wherein
the imaging cycle is a frame cycle of the image data.

3. The image processing device as claimed in claim 1, wherein
the particular region is a face region of a person as a photographic subject.

4. The image processing device as claimed in claim 1, further comprising a memory controller for storing the inputted image data in a memory, wherein
the motion detection processor detects the motion vector of the image data read from the memory via the memory controller, and
the particular region detection processor detects the particular region in the image data read from the memory via the memory controller to thereby generate the particular region position information.

5. The image processing device as claimed in claim 1, wherein
the particular region corrector calculates the predicted particular region position information by adding the predicted motion amount corresponding to a time difference (positional difference) from the imaging periodic point at which the detection of the particular region by the particular region detection processor starts to the imaging periodic point at which a particular region detection frame is displayed to the particular region position information when the predicted motion amount is calculated.

6. The image processing device as claimed in claim 5, wherein
the particular region corrector generates on-screen data for displaying the particular region detection frame at a coordinate position on a screen shown by the predicted particular region position information.

7. The image processing device as claimed in claim 1, wherein
the particular region corrector calculates the predicted particular region position information by adding the predicted motion amount corresponding to a time difference from the imaging periodic point at which the detection of the particular region by the particular region detection processor starts to the imaging periodic point at which the image data is fetched to the particular region position information when the predicted motion amount is calculated at the imaging periodic point at which the next image data is fetched.

8. The image processing device as claimed in claim 7, wherein
the particular region corrector indicates a coordinate position on a screen shown by the predicted particular region position information as a coordinate position on the screen where an evaluation value for at least one of autofocus, automatic exposure and white balance is obtained.

9. The image processing device as claimed in claim 1, further comprising a resizing processor for size-reducing the image data to be displayed and gain-adjusting the size-reduced image data and also size-reducing the image data for the detection of the particular region and gain-adjusting the size-reduced image data, wherein
the particular region detection processor detects the particular region based on the image data size-reduced by the resizing processor.

10. The image processing device as claimed in claim 1, wherein
the image processing device further comprising:
a first resizing processor for size-reducing the image data to be displayed and gain-adjusting the size-reduced image data;
a second resizing processor for size-reducing the image data size-reduced for display so that the image data is used for the detection of the particular region and gain-adjusting the size-reduced image data; and
a particular region detection memory in which the image data size-reduced for the detection of the particular region is stored, wherein
the particular region detection processor detects the particular region based on the image data size-reduced for the detection of the particular region which is read from the particular region detection memory.

11. An imaging device comprising:
an imaging unit;
a memory in which the image data outputted from the imaging unit is stored; and
the image processing device as claimed in claim 1 for image-processing the image data read from the memory via the memory controller.
